(19) United States
(12) Patent Application Publication
(10) Pub. No.: US 2014/0316128 A1
(43) Pub. Date: Oct. 23, 2014

(54) Preparation Of Oligosaccharides Containing Amine Groups

(71) Applicant: BASF SE, Ludwigshafen (DE)

(72) Inventors: Mari Granström, Mannheim (DE); Volker Wendel, Seeheim-Jugenheim (DE); Anja Suckert, Mannheim (DE); Claudia Wood, Weinheim (DE); Helmuth Völlmar, Mannheim (DE); Anni Knab, Worms (DE); Alois Kindler, Grunstadt (DE); Marta Zajaczkowski-Fischer, Neuhofen (DE)

(21) Appl. No.: 14/351,222

(22) PCT Filed: Oct. 4, 2012
(86) PCT No.: PCT/EP2012/069614

§ 371 Date: Apr. 11, 2014

(30) Foreign Application Priority Data
Oct. 4, 2011 (EP) 11185143.2

(51) Int. Cl. C08B 15/06

(52) U.S. Cl. CPC C08B 15/06
USPC 536/30; 536/55.3

(57) ABSTRACT

Described are oligo- and polysaccharides containing amine groups. Specifically, described is a new process to manufacture cationic cellulose oligomers. The new cationic oligo- or polysaccharides are useful ingredients in various aqueous compositions, inter alia as ingredients for personal care compositions.

### CROSS-REFERENCE TO RELATED APPLICATIONS

This application is the national stage entry of PCT/EP2012/069614, filed on Oct. 4, 2012 which claims priority to European Patent application number 11185143.2, filed on Oct. 14, 2011, both of which are incorporated herein by reference in their entireties.

### TECHNICAL FIELD

The present invention relates to oligo- and polysaccharides containing amine groups. More particularly, the present invention is directed towards a new process to manufacture cationic cellulose oligomers. The new cationic oligo- or polysaccharides are shown to be useful ingredients in various aqueous compositions, inter alia as ingredients for personal care compositions.

### BACKGROUND

Known commercially available cationic polymers comprising cellulose are e.g. Polyquaternium-4 (PQ-4), PQ-10, and PQ-24.

These cationic materials possess relatively high molecular weights and their preparation is based on the amination of already modified cellulose like e.g. Hydroxyethylcellulose (HEC).

To date no low molecular weight cationic cellulose oligomers for the usage in cosmetic compositions are commercially available.

In the past cationic polysaccharides were generally prepared by etherification of polysaccharides with aqueous alkali and alkyl halides containing amine groups (U/S. Pat. No. 1,777,970).

Carbohydrate Polymers 18 (1992) 283-288 gives an overview on the preparation of Diethylaminoethyl starch (DEAE starch) and 2-hydroxy-3-trimethylammoniopropyl starch (HTMAP starch). The cationic starch derivatives, the structure of which was investigated there by NMR, were manufactored by etherification under aqueous alkaline conditions with diethylaminoethyl chloride HCl salt, 3-chloro-2-hydroxypropyltrimethylammonium chloride, and 3-chloropropyltrimethylammonium chloride as etherification agents.

There have been two major methods for the syntheses of 6-amino-6-deoxycellulose derivatives, either via a 6-azidodeoxycellulose derivative (which can be prepared from a 6-tosylated cellulose derivative or a 6-chlorodeoxycellulose derivative), or by synthesis via a 6-oxidized cellulose derivative.

Matsui et al. (Carbohydr Res. 2005, 340 (7),1403-6) discloses the synthesis of 6-amino-6-deoxycellulose from cellulose by three reaction steps, namely bromination at C-6, displacement of bromine by azide ion, and reduction of the azide group to amino group, in 67% overall yield. The degree of substitution of compound 4 was 0.96.

Liu and Baumann (Carbohydrate Research 340 (2005) 2229-2235) describe, New 6-butylamino-6-deoxycellulose and 6-deoxy-6-pyridiniumcellulose derivatives with highest regioselectivity and completeness of reaction”. A completely C-6 tosylated cellulose derivative was used to study the nucleophilic substitution with butylamine and pyridine to yield 6-butylamino-6-deoxycellulose and 6-deoxy-6-pyridiniumcellulose derivatives, respectively.

In their article “Adsorption Behavior of Waste Paper Gels Chemically Modified with Functional Groups of Primary Amine and Ethylenediamine for Some Metal Ions” (Solvent Extraction and Ion Exchange 25: 845-855, 2007) Kawakita et al. describe the amination of paper, i.e. high molecular weight cellulose by first reacting the paper with thionylchloride and subsequent reaction of the chlorinated paper with ammonia or ethylenediamine.

### SUMMARY

A first aspect of the present invention is directed to a process for aminating polysaccharides or oligosaccharides. In a first embodiment, the process comprises the steps a. dissolving a polysaccharide or oligosaccharide in a solvent system which comprises at least one ionic liquid, b. reacting the dissolved polysaccharides or oligosaccharides with a chlorinating agent, and c. reacting the chlorinated polysaccharides or oligosaccharides received from step b) with an aminating agent.

In a second embodiment, the process of the first embodiment is modified, wherein the polysaccharide or oligosaccharide is cellulose, hemicellulose, or chemically modified cellulose.

In a third embodiment, the process of the first and second embodiments is modified, wherein the ionic liquid is an imidazolium salt.

In a fourth embodiment, the process of the first through third embodiments is modified, wherein the solvent system is a mixture of solvents comprising at least one ionic liquid and at least one non-ionic solvent.

In a fifth embodiment, the process of the first through fourth embodiments is modified, wherein the aminating agent is selected from ammonia, ammonia-releasing compounds, primary amines, secondary amines, and tertiary amines.

In a sixth embodiment, the process of the first through fifth embodiments is modified, wherein the aminating agent is selected from n-butylamine, trimethylamine, ethanolamine, sodium azide, and mixtures thereof.

In a seventh embodiment, the process of the first through sixth embodiments is modified, wherein the chlorinated polysaccharide or oligosaccharide has a degree of subsitution DS of 0.5 to 3 and a degree of polymerization DP of 10 to 100.

In an eighth embodiment, the process of the first through seventh embodiments is modified, wherein step c) is carried out in liquid phase.

### BRIEF DESCRIPTION OF THE DRAWINGS

FIG. 1 shows the chemical structures of cellulose according to the Examples; and

FIG. 2 is an NMR spectrum of cellulose prepared according to the Examples.

### DETAILED DESCRIPTION

Provided is a smooth, economic, and efficient way to prepare cationic celluloses with relatively low molecular weights. Such oligomers open up new possibilities in different applications areas in which high molecular weight celluloses are rather disadvantageous.

In one or more embodiments of this invention is a process for aminating polysaccharides or oligosaccharides comprising the steps
A) dissolving a polysaccharide or oligosaccharide in a solvent system which comprises at least one ionic liquid,
B) reacting the polysaccharides or oligosaccharides with a chlorinating agent,
C) reacting the chlorinated polysaccharides or oligosaccharides received from step B) with an aminating agent.

Steps A) and B) have been described in WO 2011/086082, the disclosure of which is hereby incorporated by reference.

Step A)

In step A) of the process a polysaccharide or oligosaccharide is dissolved in a solvent system which comprises at least one ionic liquid.

Examples of polysaccharides or oligosaccharides include cellulose, hemicellulose and also starch, glycogen, dextran and tunicin. Further examples are the polycondensates of D-fructose, e.g. inulin, and also, inter alia, chitin, and alginic acid. The polysaccharides or oligosaccharides, in particular cellulose, may to some extent be chemically modified, for example by etherification or esterification of hydroxyl groups.

In one or more embodiments, the polysaccharide or oligosaccharide is selected from cellulose, hemicellulose, and chemically modified cellulose.

In a specific embodiment, cellulose is used as polysaccharide. Most preferably the cellulose used is unmodified.

Specific poly- or oligosaccharides, in particular cellulose, used for the process have a degree of polymerization (DP) of at least 50, more preferably of at least 150 or most specific of at least 300. The maximum DP may, for example, be 1000, more preferably 800 or at maximum 600.

The degree of polymerization (DP) is the number of repeat units in an average polymer chain. DP can be calculated as follows: DP=Total M_{w} of the polymer/M_{w} of the repeating unit. The molecular weight M_{w} is the weight average molecular weight. DP can be measured by Gel Permeable Chromatography (GPC) or Size Exclusion Chromatography (SEC).

Solvent System and Ionic Liquid

The solvent system may be one solvent or a mixture of solvents. The solvent system might be an ionic liquid, only, or a mixture of different ionic liquids or a mixture of ionic liquids and other organic, non-ionic solvents.

As non-ionic solvents polar solvents which can be mixed homogeneously with ionic liquids and do not lead to precipitation of the polysaccharide may be used, for example ethers or ketons, for example dioxane, dimethyl sulfoxide, dimethylformamide, dimethylacetamide or sulfolane.

In a specific embodiment of the invention, the solvent system comprises dioxane.

The content of ionic liquids in the solvent system is preferably at least 20% by weight, more preferably at least 50% by weight and most preferably at least 80% or 90% by weight.

In one specific embodiment of the invention the solvent system is a mixture comprising one or more ionic liquids and at least one non ionic solvent, preferably dioxane. In one specific embodiment of this invention the solvent system comprises 20 to 90% by weight ionic liquids. The remainder comprises non-ionic solvents or solvents.

The solvent system according to one or more embodiments has no content or only a low content of water of below 5% by weight. In particular embodiments, the content of water is below 2% by weight.

As used herein, the term ionic liquid refers to salts (compounds composed of cations and anions) which at atmospheric pressure (1 bar) have a melting point of less than 200° C., specifically less than 150° C., particularly less than 100° C. and very specifically less than 80° C.

In a specific embodiment, the ionic liquids are liquid under normal conditions (1 bar, 21° C.), i.e. at room temperature.

Specific ionic liquids comprise an organic compound as cation (organic cation). Depending on the valence of the anion, the ionic liquid can comprise further cations, including metal cations, in addition to the organic cation.

The cations of specific ionic liquids are exclusively an organic cation or, in the case of polyvalent anions, a mixture of different organic cations.

Suitable organic cations are, in particular, organic compounds comprising heteroatoms such as nitrogen, sulfur, oxygen or phosphorus; in particular, the organic cations are compounds comprising an ammonium group (ammonium cations), an oxonium group (oxonium cations), a sulfonium group (sulfonium cations) or a phosphonium group (phosphonium cations).

In a particular embodiment, the organic cations of the ionic liquid are ammonium cations, which for the present purposes are non aromatic compounds having a localized positive charge on the nitrogen atom, e.g. compounds comprising tetravalent nitrogen (quaternary ammonium compounds) or compounds comprising trivalent nitrogen, with one bond being a double bond, or aromatic compounds having a delocalized positive charge and at least one nitrogen atom, specifically one or two nitrogen atoms, in the aromatic ring system.

Specific organic cations are quaternary ammonium cations which have three or four aliphatic substituents, specifically C1-C12-alkyl groups, which may optionally be substituted by hydroxyl groups, on the nitrogen atoms.

Particular preference is given to organic cations which comprise a heterocyclic ring system having one or two nitrogen atoms as constituent of the ring system.

Monocyclic, bicyclic, aromatic or nonaromatic ring systems are possible. Mention may be made of, for example, bicyclic systems as described in WO 2008/043837. The bicyclic systems of WO 2008/043837 are diazabicyclo derivatives, preferably made up of a 7-membered ring and a 6-membered ring, which comprise an amidinium group; particular mention may be made of the 1,8-diazabicyclo[5.4.0]undec-7-enium cation.

Very specific organic cations comprise a five- or six-membered heterocyclic ring system having one or two nitrogen atoms as constituent of the ring system.

Possible organic cations of this type are, for example, pyridinium cations, pyridazinium cations, pyrimidinium cations, pyrazinium cations, imidazolium cations, pyrazolium cations, pyrazolinium cations, imidazolinium cations, thiazolium cations, triazolium cations, pyrrolidinium cations and imidazolidinium cations. These cations are, for example, mentioned in WO 2005/113702. The nitrogen atoms of the cations are substituted by hydrogen or an organic group which generally has not more than 20 carbon atoms, preferably a hydrocarbon group, in particular a C1-C16-alkyl group, in particular a C1-C10-alkyl group, particularly preferably a C1-C4-alkyl group, if such substitution is necessary to have a positive charge.

The carbon atoms of the ring system can also be substituted by organic groups which generally have not more than 20 carbon atoms, preferably a hydrocarbon group, in particular a C1-C16-alkyl group, in particular a C1-C10-alkyl group, particularly preferably a C1-C4-alkyl group.

Particularly specific ammonium cations are quaternary ammonium cations, imidazolium cations, pyrimidinium cations and pyrazolium cations.

In one or more embodiments, the ammonium cations are imidazolium cations of formula I

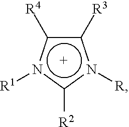

pyridinium cations of formula II

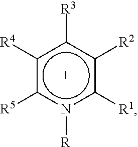

and pyrazolium cations of formula III

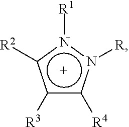

wherein the radicals have the following meaning:

R is an organic group with 1 to 20 carbon atoms and

R¹ to R⁵ are, independently from each other, a hydrogen atom or an organic group with 1 to 20 carbon atoms, in case of imidazolium (formula I) and pyrazolium cations (formula Iii), R¹ in specific embodiments is an organic group with 1 to 20 carbon atoms.

Most preferred are imidazolium cations of formula I; in particular imidazolium cations where R and R¹ are each an organic radical having from 1 to 20 carbon atoms and R², R³, and R⁴ are each an H atom or an organic radical having from 1 to 20 carbon atoms.

In the imidazolium cation of formula I, preference is given to R and R¹ each being, independently of one another, an organic radical having from 1 to 10 carbon atoms. In particular, R and R¹ are each an aliphatic radical, in particular an aliphatic radical without further heteroatoms, e.g. an alkyl group. Particular preference is given to R and R¹ each being, independently of one another, a C1-C10- or C1-C4-alkyl group.

In the imidazolium cation of formula I, preference is given to R², R³ and R⁴ each being, independently of one another, an H atom or an organic radical having from 1 to 10 carbon atoms; in particular R², R³ and R⁴ are each an H atom or an aliphatic radical. Particular preference is given to R², R³ and R⁴ each being, independently of one another, an H atom or an alkyl group; in particular R², R³ and R⁴ are each, independently of one another, an H atom or a C1-C4-alkyl group. Very particular preference is given to R², R³ and R⁴ each being an H atom.

The ionic liquids can comprise inorganic or organic anions. Such anions are mentioned, for example, in the abovementioned WO 03/029329, WO 2007/076979, WO 2006/000197 and WO 2007/128268.

Possible anions are, in particular, anions from the following groups:

The group of halides and halogen-comprising compounds of the formulae:

F⁻, Cl⁻, Br⁻, I⁻, BF₄⁻, PF₆⁻, AlCl₄⁻, Al₂Cl₇⁻, Al₃Cl₁₀⁻, AlBr₄⁻, FeCl₄⁻, BCl₄⁻, SbF₆⁻, AsF₆, ZnCl₃⁻, SnCl₃⁻, CuCl₂⁻, CF₃SO₃⁻, (CF₃SO₃)₂N⁻, CF₃CO₂⁻, CCl₃CO₂⁻, CN⁻, SCN⁻, OCN⁻, NO²⁻, NO³⁻, N(CN)⁻;

the group of sulfates, sulfites, and sulfonates of the general formulae:

SO₄²⁻, HSO₄⁻, SO₃²⁻, HSO₃⁻, R^{a}OSO₃⁻, R^{a}SO₃⁻;

the group of phosphates of the general formulae:

PO₄³⁻, HPO₄²⁻, H₂PO₄⁻, R^{a}PO₄²⁻, HR^{a}PO₄⁻, R^{a}R^{b}PO₄⁻;

The group of phosphonates and phosphinates of the general formulae:

R^{a}HPO₃⁻, R^{a}R^{b}PO₂⁻, R^{a}R^{b}PO₃⁻;

the group of phosphites of the general formulae:

PO₃³⁻, HPO₃²⁻, H₂PO₃⁻, R^{a}PO₃²⁻, R^{a}HPO₃⁻, R^{a}R^{b}PO₃⁻;

the group of phosphonites and phospinites of the general formulae:

R^{a}R^{b}PO₂⁻, R^{a}HPO₂⁻, R^{a}R^{b}PO⁻, R^{a}HPO⁻;

the group of carboxylates of the general formula:

R^{a}COO⁻;

the group of borates of the general formulae:

BO₃³⁻, HBO₃²⁻, H₂BO₃⁻, R^{a}R^{b}BO₃⁻, R^{a}HBO₃⁻, RaBO₃²⁻, B(OR^{a})(OR^{b})(OR^{c})(OR^{d})⁻, B(HSO₄)⁻, B(R^{a}SO4)⁻;

the group of boronates of the general formulae:

R^{a}BO₂²⁻, R^{a}R^{b}BO⁻;

the group of carbonates and carbonic esters of the general formulae:

HCO₃⁻, CO₃²⁻, RaCO₃⁻;

the group of silicates and silicic esters of the general formulae:

SiO₄⁴⁻, HSiO₄³⁻, H₂SiO₄²⁻, H₃SiO₄₋, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻;

the group of alkylsilane and arylsilane salts of the general formulae:

R^{a}SiO₃³⁻, R^{a}R^{b}SiO₂²⁻, R^{a}R^{b}R^{c} SiO⁻, R^{a}R^{b}R^{c}SiO₃⁻, R^{a}R^{b}R^{c}SiO₂⁻, R^{a}R^{b}SiO₃²⁻;

the group of carboximides, bis(sulfonyl)imides and sulfonylimides of the general formulae:

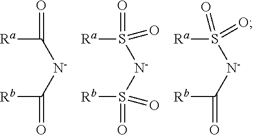

the group of methides of the general formula:

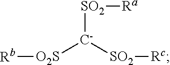

the group of alkoxides and aryloxides of the general formula:

R^{a}O⁻;

the group of halometalates of the general formula:

[MᵣHalₜ]⁺,

wherein M is a metal and Hal is fluorine, chlorine, bromine, or iodine, r and t are positive integers and indicate the stoichiometry of the complex, and s is a positive integer and indicates the charge on the complex;

the group of sulfides, hydrogensulfides, polysulfides, hydrogenpolysulfides and thiolates of the general formulae:

S²⁻, HS⁻, [Sᵥ]²⁻, [HSᵥ]⁻, [R^{a}S]⁻,

wherein v is a positive integer from 2 to 10; and

the group of complex metal ions such as Fe(CN)₆³⁻, Fe(CN)₆⁴⁻, MnO₄⁻, Fe(CO)₄⁻.

In the above anions, R^{a}, R^{b}, R^{c} and R^{d} are each independently of one another, hydrogen;

C₁-C₃₀-alkyl and aryl-, heteroaryl-, cycloalkyl-, halogen-, hydroxy-, amino-, carboxy-, formyl-, —O—, —CO—, —CO—O— or —CO—N< substituted derivatives thereof, for example methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1 -butyl, 3,3-dimethyl-1-butyl, 2-ethyl-1 -butyl, 2,3-dimethyl-2-butyl, 3,3-dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tri-cosyl, tetracosyl, pentacosyl, hexacosyl, heptacosyl, octacosyl, nonacosyl, triacontyl, phenylmethyl (benzyl), diphenylmethyl, triphenylmethyl, 2-phenylethyl, 3-phenylpropyl, cyclopentylmethyl, 2-cyclopentylethyl, 3-cyclopentylpropyl, cyclohexylmethyl, 2-cyclohexylethyl, 3-cyclohexylpropyl, methoxy, ethoxy, formyl, acetyl or C_{q}F_{2(q-a)+c(1-b)}H_{2a+b} where q≦30, 0≦a≦q and b=0 or 1 (for example CF₃, C₂F₅, CH₂CH₂—C_{(q-2)}F_{2(q-2)-1}, C₆^{F}₁₃, C₈F₁₇, C₁₀F₂₁, C₁₂F₂₅);

C₃-C₁₂-cycloalkyl and aryl-, heteroaryl-, cycloalkyl-, halogen-, hydroxy-, amino-, carboxy-, formyl-, —O—, —CO— or —CO—O-substituted derivatives thereof, for example cyclopentyl, 2-methyl-1-cyclopentyl, 3-methyl-1-cyclopentyl, cyclohexyl, 2-methyl-1-cyclohexyl, 3-methyl-1-cyclohexyl, 4-methyl-1-cyclohexyl or C_{q}F_{2(q-a)-(1-b)}H_{2a-b} where q≦30, 0≦a≦q and b=0 or 1;

C₂-C₃₀-alkenyl and aryl-, heteroaryl-, cycloalkyl-, halogen-, hydroxy-, amino-, carboxy-, formyl-, —O—, —CO— or —CO—O-substituted derivatives thereof, for example 2-propenyl, 3-butenyl, cis-2-butenyl, trans-2-butenyl or C_{q}F_{2(q-a)-(1-b})H_{2a-b} where q≦30, 0≦a≦q and b=0 or 1;

C₃-C₁₂-cycloalkenyl and aryl-, heteroaryl-, cycloalkyl-, halogen-, hydroxy-, amino-, carboxy-, formyl-, —O—, —CO— or —CO—O-substituted derivatives thereof, for example 3-cyclopentenyl, 2-cyclohexenyl, 3-cyclohexenyl, 2,5-cyclohexadienyl or C_{q}F_{2(q-a)-3(1-b)}H_{2a-3b} where q≦30, 0≦a≦q and b=0 or 1;

Aryl or heteroaryl having from 2 to 30 carbon atoms and alkyl-, aryl-, heteroaryl-, cycloalkyl-, halogen-, hydroxy-, amino-, carboxy-, formyl-, —O—, —CO— or —CO—O-substituted derivatives thereof, for example phenyl, 2-methylphenyl (2-tolyl), 3-methylphenyl (3-tolyl), 4-methylphenyl, 2-ethylphenyl, 3-ethylphenyl, 4-ethylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 4-phenylphenyl, 1-naphthyl, 2-naphthyl, 1-pyrrolyl, 2-pyrrolyl, 3-pyrrolyl, 2-pyridinyl, 3-pyridinyl, 4-pyridinyl or C₆F₍₅₋ₐ₎Hₐ where 0≦a≦5; or

two radicals form an unsaturated, saturated or aromatic ring which is optionally substituted by functional groups, aryl, alkyl, aryloxy, alkyloxy, halogen, heteroatoms and/or heterocycles and optionally interrupted by one or more oxygen and/or sulfur atoms and/or one or more substituted or unsubstituted imino groups.

This foregoing definition also applies for the organic substituents R^{a}, R^{b}, and R^{c} of the aminating agent of the general formula NR^{a}R^{b}R^{c} which is used in step C) and described in more detail further below.

In the above anions, preference is given to R^{a}, R^{b}, R^{c} and R^{d} each being, independently of one another, a hydrogen atom or a C1-C12-alkyl group.

Anions which may be mentioned are, for example, chloride; bromide; iodide; thiocyanate; hexafluorophosphate; trifluoromethanesulfonate; methanesulfonate; the carboxylates, in particular formate; acetate; mandelate; nitrate; nitrite; trifluoroacetate; sulfate; hydrogensulfate; methylsulfate; ethylsulfate; 1-propylsulfate; 1-butylsulfate; 1-hexylsulfate; 1-octylsulfate; phosphate; dihydrogenphosphate; hydrogenphosphate; C1-C4-dialkylphosphates; propionate; tetrachloroaluminate; Al₂Cl₇³¹ ; chlorozincate; chloroferrate; bis(trifluoromethylsulfonyl)imide; bis(pentafluoroethylsulfonyl)imide; bis(methylsulfonyl)imide; bis(p-toluenesulfonyl)imide; tris(trifluoromethylsulfonyl)-methide; bis(pentafluoroethylsulfonyl)methide; p-toluenesulfonate; tetracarbonylcobaltate; dimethylene glycol monomethyl ether sulfate; oleate; stearate; acrylate; methacrylate; maleate; hydrogencitrate; vinylphosphonate; bis(pentafluoroethyl)phosphinate; borates such as bis [salicylato(2-)]borate, bis [oxalato (2-)]borate, bis[1,2-benzenediolato (2-)-O,O′]borate, tetracyanoborate, tetrafluoroborate; dicyanamide; tris(pentafluoroethyl)trifluorophosphate; tris(heptafluoropropyl)trifluorophosphate, cyclic arylphosphates such as catecholphosphate (C₆H₄O₂)P(O)O and chlorocobaltate.

Particularly specific anions are anions from the group consisting of

alkylsulfates

R^{a}OSO₃⁻,

where R^{a} is a C1-C12-alkyl group, preferably a C1-C6-alkyl group, alkylsulfonates

R^{a}SO₃⁻;

where R^{a} is a C1-C12 alkyl group, preferably a C1-C6-alkyl group,

halides, in particular chloride and bromide, and

pseudohalides, such as thiocyanate, dicyanamide,

carboxylates R^{a}COO⁻;

where R^{a} is a C1-C20-alkyl group, preferably a C1-C8-alkyl group, in particular acetate,

phosphates,

in particular dialkylphosphates of the formula R^{a}R^{b}PO₄⁻, where R^{a} and R^{b} are each, independently of one another, C1-C6-alkyl groups; in particular, R^{a} and R^{b} are the same alkyl group, for example dimethylphosphate and diethylphosphate,

and phosphonates, in particular monoalkylphosphonic esters of the formula R^{a}R^{b}PO₃⁻, where R^{a} and R^{b} are each, independently of one another, a C1-C6-alkyl group.

Very specific anions are:

chloride, bromide, hydrogensulfate, tetrachloroaluminate, thiocyanate, dicyanamide, methylsulfate, ethylsulfate, methanesulfonate, formate, acetate, dimethylphosphate, diethylphosphate, p-toluenesulfonate, tetrafluoroborate and hexafluorophosphate, methylmethylphosphonate (methylester of methylphosphonate).

Particularly specific ionic liquids consist exclusively of an organic cation together with one of the anions mentioned.

Most preferred are imdazolium salts with an imidazolium cation according to formula I and one of the above anions, specifically one of the particularly specific anions, specifically acetate, chloride, dimethylphosphate or diethylphosphate or methylmethylphosphonate. Most preffered is acetate or chloride.

In one or more embodiments, the molecular weight of the ionic liquid is less than 2000 g/mol, particularly less than 1500 g/mol, less than 1000 g/mol and very specifically less than 750 g/mol;

in a particular embodiment, the molecular weight is in the range from 100 to 750 g/mol or in the range from 100 to 500 g/mol.

In one embodiment of this invention, the ionic liquid comprises 1-butyl-3-methyl imidazolium chloride.

Preparation of the Solution

In the process of the invention, a solution of the poly- or oligosaccharide, preferably cellulose, in the solvent system is prepared. The concentration of the poly- or oligosaccharide can be varied within a wide range. It is usually in the range from 0.1 to 50% by weight, based on the total weight of the solution, or from 0.2 to 40% by weight, or from 0.3 to 30% by weight or from 0.5 to 20% by weight.

This dissolution procedure can be carried out at room temperature or with heating, but above the melting point or softening temperature of the ionic liquid, usually at a temperature of from 0 to 200° C., or from 20 to 180° C., or from 50 to 150° C. However, it is also possible to accelerate dissolution by intensive stirring or mixing or by introduction of microwave or ultrasonic energy or by a combination of these. If a solvent system comprising ionic liquids and non-ionic solvents is used, the poly- or oligosaccharide may be dissolved in the ionic liquid first and the non-ionic solvent be added thereafter.

Step B)

In step B) the poly- or oligosaccharides, preferably cellulose, are reacted with a chlorinating agent.

The chlorinating agent may, for example, be added as such or in form of a solution in an appropriate solvent to the solution obtained after step A).

Usual chlorinating agents may be used, for example thionyl chloride, methanesulfonyl chloride, chlorodimethyliminium chloride, phosphoryl chloride or para-toluenesulfonic chloride.

A specific chlorinating agent is thionyl chloride.

The chlorinating agent should be added at least in amounts to achieve the desired degree of substitution.

The degree of substitution (DS) of poly- or oligosaccharides is the average number of hydroxyl groups per six-ring unit of the polysaccharides or oligosaccharides substituted by a chloride.

The degree of substitution (DS) of a given chlorinate cellulose is defined as the average number of substituted hydroxyl groups per anhydroglucose unit (AGU).

DS is determined from the chlorine content detected in elemental analysis.

In one or more embodiments, the chlorinated polysaccharides or oligosaccharides obtained by the process of the invention have a degree of substitution (DS) of at least 0.5.

There are 3 hydroxyl groups in the AGU of cellulose and thus the theoretical maximum of the DS in chlorinated cellulose is 3.0.The first hydroxyl group in cellulose to be substituted by a chlorine atom will usually be the hydroxyl of the hydroxyl-methylene-group.

A specific DS of the chlorinated cellulose obtained by the process of the invention is 0.5 to 3, more specific is a DS of 0.8 to 3. Suitable chlorinated cellulose obtained by the process of the instant invention may have, for example a DS of 0.5 to 1.5 or from 0.8 to 1.5.

With the process of the invention a DS in chlorinated cellulose of at least 1.0 can be easily achieved.

The chlorinating agent may be added in excess, which means that more chlorinating agent may be added than required for the maximum DS. Non-reacted chlorinating agents may be removed by usual means, thionyl chloride may, for example, be removed by evaporation.

The chlorinating agent, in particular thionyl chloride, does not only effect the substitution of the hydroxyl group by a chlorine atom but leads also to a degradation of the poly- or oligosaccharides, in particular cellulose. This degradation is caused by the fact that the chlorinating agent hydrolyzes the oxygen bridging between the repeating units of the main chain of the oligo- or polysaccharide (β-1,4-glycosidic bonds.

Thus the process of the instant invention is in fact also a process for chlorinating and hydrolyzing poly- or oligosaccharides.

Hence the obtained chlorinated poly- or oligosaccharides, for example chlorinated cellulose, preferably have a DP which is lower less than the DP of the non-chlorinated polysaccharides or oligosaccharides, in particular the DP of the obtained chlorinated poly- or oligosaccharides may be less than 90%, less than 80%, less than 50%, and less than 20% or even less than 10% of the DP of the non chlorinated starting material.

For example, starting with specific cellulose which may have a DP of 50 to 1000, more preferably of 100 to 800 (see above), degraded chlorinated cellulose may be obtained with a DP of less than 100, for example with a DP of 5 to 100, or of 10 to 100, or of 10 to 50.

Thus with the process of the invention a chlorinated cellulose is obtained which may have, for example, a DS of 0.5 to 3, specifically of 0.5 to 1.5 and a DP of 10 to100, specifically of 10 to 50. Most specific is chlorinated cellulose with a DS of 0.5 to 1.5 and a DP of 5 to 100 or chlorinated cellulose of a DS of 0.8 to 1.5 and a DP of 10 to 50.

According to one or more embodiments, during the chlorinating reaction, the reaction mixture is kept at an elevated temperature; the temperature may be for example from 30 to 150° C., or from 80 to 130° C. at ambient pressure (1 bar).

In general, the reaction is carried out in air. However, it is also possible to carry it out under inert gas, i.e., for example, under N₂, a noble gas or a mixture thereof.

Temperature and reaction time may be selected to achieve the desired degree of DS and DP. For the degradation no further additives like acids or nucleophiles (see WO 2007/101811, degradation by the use of acids or WO 2007/101813, degradation by nucleophils) are required. Also the use of a base is not required. In a specific embodiment the chlorination is performed in absence of an additional base.

As a product of the process solutions are obtained which comprise ionic liquid and chlorinated polysaccharides or oligosaccharides.

The chlorinated polysaccharides or oligosaccharides may be isolated from such solutions, if desired, by usual means.

The chlorinated polysaccharides or oligosaccharides may, for example, be obtained from the solution by adding a coagulating solvent (non-solvent for chlorinated polysaccharides or oligosaccharides) or other coagulating agent, in particular a base or basic salt, for example ammonia or a solution comprising NH₄OH and separating the coagulated chlorinated polysaccharides or oligosaccharides from the solvent system.

The isolated chlorinated polysaccharides or oligosaccharides, in particular chlorinated cellulose, may be obtained in specific shapes. If desired it can be obtained in form of fibers, films or pearls, depending on the specific conditions under which the chlorinated polysaccharides or oligosaccharides are precipitated.

The isolated or precipitated chlorinated polysaccharides or oligosaccharides could be dried to remove residual solvent.

The solution of polysaccharides or oligosaccharides or the polysaccharides or oligosaccharides isolated from such solution are useful for various technical applications. Chlorinated cellulose of low DP (oligomers) could be used as intermediates to produce cationic and amphiphilic cellulose oligomers which also have a variety of possible technical applications.

Step C)

In step C), the chlorinated polysaccharides or oligosaccharides received from step B) are reacted with an aminating agent.

The term “aminating agent” comprises all agents that are capable of substituting some or all of the chlorine atoms of the chlorinated polysaccharides or oligosaccharides received from step B) by a nitrogen containing moiety.

Examples for suitable nitrogen containing moieties are amino groups, diazo groups, and azide groups.

In one embodiment of this invention, the nitrogen containing moiety is selected from primary, secondary, and tertiary amino groups.

Examples of the aminating agent are compounds of the general formula NR^{a}R^{b}R^{c}, wherein R^{a}, R^{b}, and R^{c} have the same meaning as broadly defined before for the anions of the ionic liquid.

In one embodiment of this invention, preference is given to R^{a}, R^{b}, R^{c} and R^{d} each being, independently of one another, a hydrogen atom or a C1-C12-alkyl group.

In one embodiment of this invention, the aminating agent is selected from primary amines.

Examples of primary amines include methyl amine, ethyl amine, n-propyl amine, n-butyl amine, n-amyl amine, n-hexyl amine, lauryl amine, ethylene diamine, trimethylene diamine, tetramethylene diamine, pentamethylene diamine, hexamethylene diamine, ethanol amine, allyl amine, aniline, diethylene triamine, o-phenylene diamine, isophorone diamine, m-xylylene diamine, isopropyl amine, isobutyl amine, secondary-butyl amine, secondary-amyl amine, secondary-hexyl amine, n-heptyl amine, 2-ethyl hexyl amine, propylene diamine, tetraethylene pentamine, p-tertiary-amyl aniline, o-toluidine, o-chloroaniline, cyclohexyl amine, and isopropanol amine.

In another embodiment of this invention, the aminating agent is selected from secondary amines. Examples of secondary amines include dimethyl amine, diethyl amine, diisopropyl amine, n-dibutyl amine, diisobutyl amine, diamyl amine, dioctyl amine, methyl aniline, N-mono-n-butyl aniline, N-mono-amyl aniline, dicyclohexyl amine, diethanol amine, ethyl monoethanol amine, n-butyl monoethanol amine, and diisopropanol amine.

In another embodiment of this invention, the aminating agent is selected from tertiary amines. Examples of tertiary amines include trimethyl amine, triethyl amine, n-tributyl amine, triamyl amine, dimethyl aniline, diethyl aniline, N,N-di-n-butyl aniline, N,N-ditertiary-amyl aniline, diethyl benzyl amine, triethanol amine, diethyl ethanol amine, n-butyl diethanol amine, dimethyl ethanol amine, di-n-butyl ethanol amine, and triisopropanol amine.

In still another embodiment of this invention, the nitrogen containing moiety is or comprises the azide group —N═N⁻═N⁺.

In one specific embodiment of this invention, the aminating agent is selected from n-butylamine, tetramethylendiamin, trimethylamine, ethanolamine, and sodium azide.

In another embodiment of this invention, step C) comprises reacting the chlorinated polysaccharides or oligosaccharides received from step B) with at least two different aminating agents. Preferably one of the at least two differerent aminating agents carries at least one hydrophilic group in addition to the nitrogen containing moiety.

For example, in one embodiment of the invention, the chlorinated polysaccharides or oligosaccharides received from step B) are reacted both with ethanolamine and n-butylamine.

In one embodiment of this invention, the chlorinated polysaccharides or oligosaccharides received from step B) are reacted with at least two different aminating agents one after the other.

In another embodiment of this invention, the chlorinated polysaccharides or oligosaccharides received from step B) are reacted with a mixture of at least two different aminating agents.

In still another embodiment of this invention, the chlorinated polysaccharides or oligosaccharides received from step B) are reacted with at least one aminating agent and with at least one diol. In this case, they can be reacted with the at least one aminating agents and the at least one diol simultaneously or with one after another.

The reaction conditions to be applied during step C) strongly depend on the nature of the aminating agents.

In the case of aminating agents which are gases under standard conditions, step C) will preferably take place at elevated pressure.

In a specific embodiment of this invention, the during step C) a pressure from 10 to 100 bar, more preferably from 30 to 100 bar is applied.

In a specific embodiment of this invention step C) takes place at temperatures above 25° C.

In a specific embodiment of this invention, the temperature during step C) is from 40 to 120° C., more preferably from 60 to 100° C.

One embodiment of the invention is the process according to this invention, wherein the reaction of step C) takes place in liquid phase. Preferably, in a first step, a liquid comprising the chlorinated polysaccharides or oligosaccharides received from step B) is prepared.

For this purpose, the chlorinated polysaccharides or oligosaccharides received from step B) are preferably dispersed or still more preferably dissolved in such liquid.

In one embodiment of this invention, the liquid phase comprises liquid aminating agents or consists of liquid aminating agents.

Preferably however, the liquid phase partly comprises liquid aminating agents and additional solvents or still more preferably consists of liquid aminating agents and additional solvents. Such additional solvents are preferrably selected from aprotic solvents. Specific aprotic solvents are e.g. Dimethylformamide, N,N-Dimethylacetamide, Dimethyl sulfoxide, tetrahydrofuran, dioxane, acetonitrile, or mixtures of such solvents.

In one embodiment of this invention, step C) of the process according to this invention is carried out in the presence of bases.

In one embodiment of the invention, the bases present during step C) are selected from inorganic bases. Such inorganic bases are preferably hydroxides or carbonates of alkali or alkaline earth metals, preferably alkali metal hydroxides like e.g. potassium hydroxide or alkali metal carbonates like e.g. potassium carbonate.

In another embodiment of the invention, the bases present during step C) are selected from organic bases. Such organic bases are e.g. selected from amines like e.g. triethanolamine.

To isolate the nitrogen containing products received from step C), the aminated polysaccharides or oligosaccharides are preferably precipitated from the liquid phase.

Therefore, one embodiment of this invention is a process for aminating polysaccharides or oligosaccharides comprising the steps

A) dissolving a polysaccharide or oligosaccharide in a solvent system which comprises at least one ionic liquid,

B) reacting the polysaccharides or oligosaccharides with a chlorinating agent,

C) reacting the chlorinated polysaccharides or oligosaccharides received from step B) with an aminating agent

D) precipitating the aminated products from step C).

Such precipitation can be effected by any means known to the skilled person.

In one embodiment of this invention, step D) comprises the addition of protic solvents like e.g. water or methanol to the liquid phase received from step C).

Preferably, the resulting aminated products are washed by appropriate solvents like e.g. acetone, alcohol or alcohol/water mixtures.

In one embodiment of this invention, some or all of the N₃ groups of the azido substituted poly or oligosaccharide are reduced to amino groups.

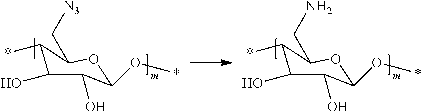

Such reduction is known to the skilled person and has e.g. been described by Scriven and Turn-bull in Chem. Rev. 1988, 88, 297-368 or Matsui et al. (Carbohydr Res. 2005, 340 (7),1403-6), Experimental 1.4.

Experimental

Chlorination of Cellulose

General Procedure

Cellulose (microcrystalline cellulose (Avicel®, DP=430) was dissolved in ionic liquid, 1-butyl-3-methyl imidazolium chloride (BMIMCl) by heating at 100° C. for 2 hours. Dioxan was added as a co-solvent. The reaction was cooled to 60° C. and thionyl chloride (5eq.) was added. The mixture was stirred at 60° C. for 2 hours after which the excess of thionyl chloride was removed in vacuum. Thereafter, he mixture was cooled to 5° C. and NH₄OH was added. The precipitate was filtered off and washed with warm water and dried in a vacuum oven at 65° C.

The degree of polymerization DP was 26 and the degree of substitution DS was 1.02. Due to the insoluble nature of the dried product, the analysis was done by CP-MAS NMR (solid state NMR), IR, SEC, and elemental analysis.

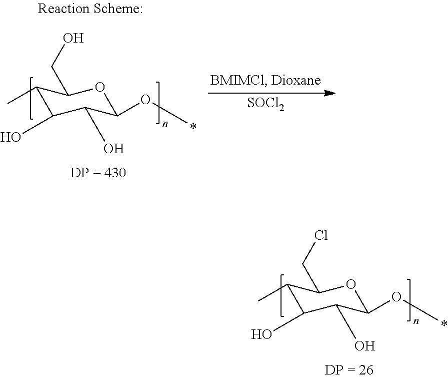

In further experiments (examples 2 and 3) the amount of cellulose was varied, temperature (60° C.), time (2 h) and amount of thionyl chloride (5eq.) were kept constant. The results of all examples are shown in Table 1:

| Example | Cellulose (g) | Yield (g) | Yield (%) | DS | DP |
|---|---|---|---|---|---|
| 1 | 4.36* | 2.8 | 58 | 1.02 | 26 |
| 2 | 8.72 | 8.9 | 91 | 0.8 | 26 |
| 3 | 8.72 | 10 | 100 | 1.13 | 24 |

Analysis of Chlorocellulose

Chlorocellulose oligomers are not accessible to solution state NMR. IR spectroscopy showed the typical CH₂—Cl vibration at 1428 cm⁻¹ and a C—Cl band at 751 cm⁻¹.

¹³C CP-MAS NMR Spectroscopy

C-6 chlorination can be seen in the ¹³C CP-MAS NMR spectrum as a high-field shift in a chemical shift for C-6 carbon. C6-C1 signal is observed at 40 ppm whereas unsubstituted C-6 (C6-OH) has a chemical shift at around 60 ppm. Dichlorination (C-6 and C-1) was seen as a shifted chemical signal of C-1 from 104 ppm to 97 ppm (C-1 chlorination) and C-6 chlorination at 40 ppm.

Aminated Polysaccharides and Oligosaccharides

As representative but not limiting examples of this invention, the syntheses of the following celluloses with nitrogen containing moieties starting from chlorinated cellulose are described below.

A1) 6-trimethylammonium-6-deoxycellulose chloride

A2) 6-n-butylamino-6-deoxycellulose

A3) 6-(2-hydroxyethylamino)-6-deoxycellulose

A4) 6-(2-hydroxyethylamino)-6-deoxycellulose-co-6-(2-hydroxyethyl)-cellulose

A5) 6-azido-6-deoxycellulose

### A1) 6-trimethylammonium-6-deoxycellulose chloride

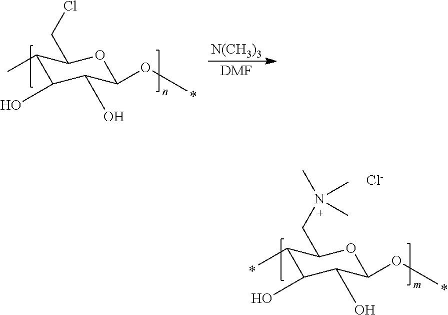

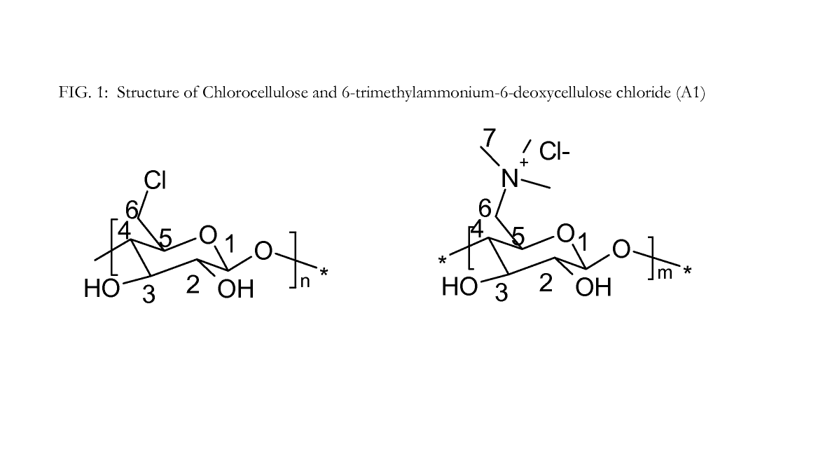

Several amination reactions with trimethylamine (TMA) were carried out in order to see the impact of the reaction time, the degree of polymerization (DP) of the chlorocellulose oligomer (Cl-Cell) and the amount of trimethylamine on the resulting products. The chemical structures of the starting material and product are depicted in FIG. 1.

Chlorocellulose (5 g) was dissolved in dry DMF (100 mL) in an autoclave under nitrogen atmosphere. Trimethylamine (8.6 g) was added and the reaction was heated and stirred (500 rpm) at about 80° C. for a particular time, and compressed with nitrogen to a particular pressure (see Table 2 below). Changes in pressure were recorded.

The products were washed with acetone, dried in vacuo and analyzed by CP-MAS NMR, IR, and elemental analysis.

Chlorocelluloses with different DP's from 21 to 115 were used as starting materials

TABLE 2
Products from reaction of chlorocellulose
(Cl-Cell) with trimethylamine (TMA) in DMF

| | Cl- | | | | | Prod- | | | |
|---|---|---|---|---|---|---|---|---|---|
| Cl- | Cell | | | Pres- | Prod- | uct | | | Prod- |
| Cell | Cl | TMA | Time | sure | uct | Cl | Yield | | uct |
| DP | % | (g) | (h) | (bar)^{a} | N %^{b} | %^{b} | % | DS^{c} | DP |
| 22 | 22 | 8.6 | 3 | 4-30-27 | 7.4 | 14 | — | — | — |
| 21 | 27.3 | 17.5 | 1 | 8-30-25 | 4.4 | 18.5 | 75 | 0.8 | 14 |
| 21 | 27.3 | 9.3 | 3 | 5-30-27 | 3.6 | 21.2 | 80 | 0.6 | 16 |
| 21 | 27.3 | 9 | 0.5 | 6-30-28 | 4 | 21 | 57 | 0.7 | 20 |
| 115 | 17.6 | 8.4 | 3 | 4-30-27 | 2.4 | 15.3 | 89 | 0.4 | 112 |
| 82 | 20.3 | 25 | 3 | 7-25-26 | 4.1 | 15.1 | 68 | 0.2 | 86 |

^{a}Starting pressure-compressed pressure-pressure after the reaction (after 20 minutes)
^{b}Theoretical weight-% of the constituents when DS = 1: Cl 14.8%, C 45.1%, O 26.7%, N 5.8% and H 7.6%
^{c}Degree of Substitution (DS) with respect to Cellulose-C-6 substituted by TMA

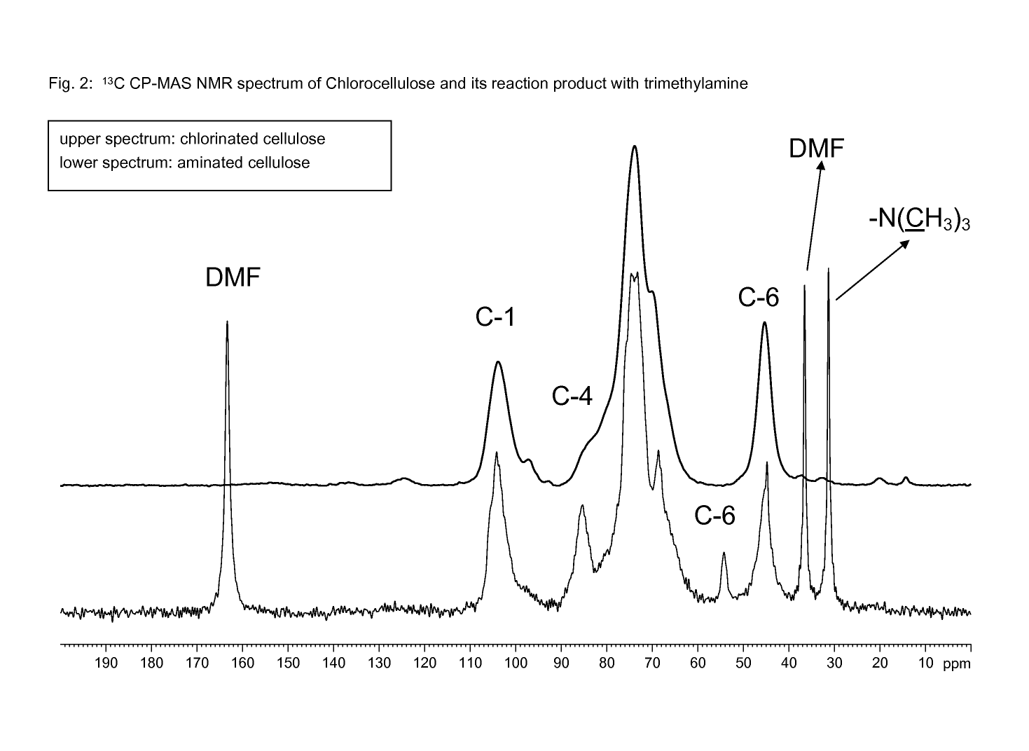

FIG. 2 shows the ¹³C CP-MAS NMR spectrum of both chlorinated starting material and aminated resulting material.

The ¹³C spectra were calibrated with respect to the low-field resonance of adamantane which was set to 38.066 ppm.

The amination of the cellulose carbon C-6 is detected by ¹³C CP-MAS NMR as a downfield shift of the C-6 carbon of the aminated cellulose. The resonance of C6-C1 is detected at ˜44 ppm whereas the resonance of C6-NR₃ is detected at ˜54 ppm. Chemical shifts for the methyl groups of TMA are detected at 31 ppm as a signal with high intensity.

### A2) 6-n-butylamino-6-deoxycellulose

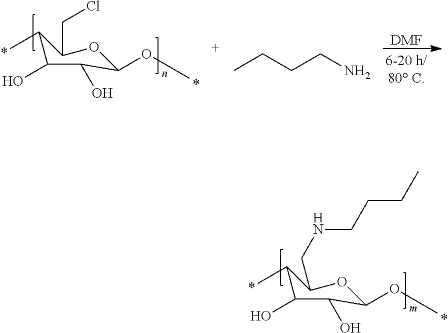

Autoclave Reaction

Chlorocellulose (10 g), n-butylamine (30 g) were dissolved in dry DMF (100 mL) and K₂CO₃ (33,1 g) was added in an autoclave.The reaction mixture was heated to about 80° C., compressed with nitrogen to about 30 bar and stirred (500 rpm) for 5 hours. Changes in pressure were recorded. The product was precipitated, washed with water and dried in vacuo. The products were then analyzed by CP-MAS NMR, IR and elemental analysis.

Flask Reaction

Chlorocellulose (20 g) was dissolved in DMF (400 mL), K₂CO₃ (53.72 g) was added and the mixture was stirred for 15 minutes at ambient temperature. n-butylamine (48.64 g) was added slowly during stirring. The reaction was kept for 15 hours at 80° C., thereafter K₂CO₃ was removed by filtration. Water (200 mL) was added to the filtrate to precipitate the product. The precipitate was then filtered, washed with water and dried in vacuo. The products were analyzed by CP-MAS NMR, IR and elemental analysis.

TABLE 3
Results of animation of Chlorocellulose (Cl-Cell) with n-butylamine (Bu—NH₂)

| Cl-Cell | Cl-Cell | BuNH2 | K2CO3 | Time | Product | Product | Yield | | Product |
|---|---|---|---|---|---|---|---|---|---|
| DP | Cl %* | (g) | (g) | (h) | N %*b | Cl %*b | % | DS | DP |
| 54 | 23.9 | 48.64 | 53.72 | 15 | 3.4 | 13.3 | 31 | 0.52 | 26 |
| 82 | 20.3 | 48.64 | 53.72 | 22 | 1.6 | 10.7 | 60 | 0.47 | 55 |
| 36 | 19.6 | 48.64 | 53.72 | 15 | 0.38 | 14.4 | 35 | 0.06 | 35 |
| 25 | 25.4 | 48.64 | 53.72 | 15 | 2.1 | 17.9 | 61.5 | 0.33 | 25 |
| 44a | 15.8 | 30 | 33.1 | 5 | 2.0 | 7.9 | 72 | 0.23 | 16 |
| 44a | 15.8 | 30 | 33.1 | 10 | 2.6 | 5.5 | 69 | 0.32 | 18 |

aProducts from autoclave reactions
*Chlorine and nitrogen contents of the cellulose samples were determined in weight-% by elemental analysis.
bTheoretical values for DS = 1: C 55.3 weight %, O 29.5 weight %, N 6.5 weight % and H 8.8 weight %

### A3) 6-(2-hydroxyethylamino)-6-deoxycellulose

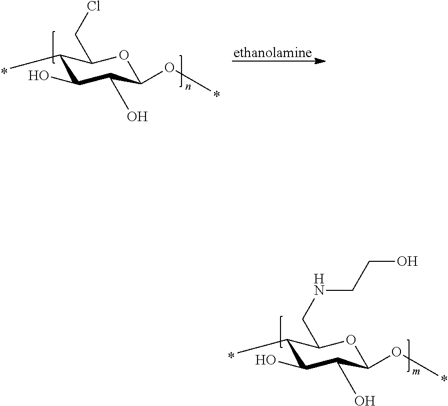

6-deoxychlorocellulose (50 g) was placed in a 1000 mL round bottom flask and ethanolamine (500 g) was added. The resulting suspension was heated to about 80° C. and stirred for about 72 hours. During this time, 6-deoxychlorocellulose was completely dissolved.

After cooling to room temperature, acetone was added (2200 ml), the resulting precipitate was filtered off, washed with Methanol/water 95:5 (150 ml) and dried at about 70° C. in vacuo over night.

TABLE 4
Products of reaction of Chlorocellulose with ethanolamine (EA).

| Reac- | | | | | | Conver- | |
|---|---|---|---|---|---|---|---|
| tion | Amount | | | Temp | Time | sion | Yield |
| No. | EA | Solvent | Base | [° C.] | [h] | [%]1 | [%] |
| 1 | 3 eq | DMF | TEA, 3 eq | 80 | 24 | <20 | <10 |
| 2 | 30 eq | — | K2CO3, 3 eq | 80 | 66 | ~50 | <50 |
| 3 | 30 eq | — | TEA, 3 eq | 80 | 66 | ~70 | ~70 |
| 4 | 30 eq | — | TEA, 3 eq | 50 | 66 | ~60 | ~50 |
| 5 | 30 eq | — | TEA, 3 eq | 80 | 90 | ~95 | ~90 |
| 6 | 30 eq | — | — | 80 | 72 | ~95 | ~95 |
| 7 | 30 eq | — | — | 100 | 24 | >95 | ~65 |
| 8 | 30 eq | — | — | 80 | 120 | >95 | ~80 |

1from elemental analysis and ¹³C-CP-MAS NMR.

### A5) 6-azido-6-deoxycellulose

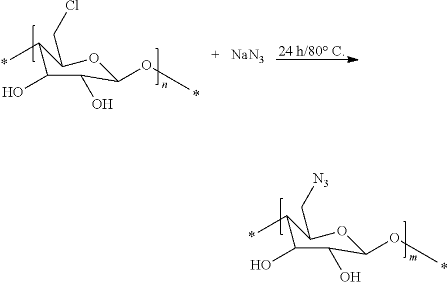

Chlorocellulose (5 g) was dissolved in 100 mL DMSO under nitrogen atmosphere in a 500 mL 4-necked flask. NaN₃ (9 g) was then added slowly and the temperature was slowly raised to 80° C. The reaction mixture was stirred at 80° C. for about 24 hours before being cooled to room temperature. Afterwards 200 mL of water were added. The resulting fine precipitate was filtered off, washed with ethanol and dried in vacuo.

¹³C CP-MAS NMR and IR spectroscopy of the product showed typical resonances and vibrations of the N₃-substituted cellulose.

Results of Elemental Analysis:

| | Azido-Cellulose | Cl-Cellulose | theory |
|---|---|---|---|
| Cl: | 5.7% | 18.0% | 0.0% |
| C: | 34.9% | 35.5% | 38.5% |
| O: | 34.0% | 38.6% | 34.2% |
| N: | 13.3% | <0.5% | 22.5% |
| H: | 5.1% | 5.1% | 4.9% |

1. A process for aminating polysaccharides or oligosaccharides comprising the steps
a. dissolving a polysaccharide or oligosaccharide in a solvent system which comprises at least one ionic liquid,
b. reacting the dissolved polysaccharides or oligosaccharides with a chlorinating agent, and
c. reacting the chlorinated polysaccharides or oligosaccharides received from step Bb) with an aminating agent.

2. The process of claim 1, wherein the polysaccharide or oligosaccharide is cellulose, hemicellulose, or chemically modified cellulose.

3. The process of claim 1, wherein the ionic liquid is an imidazolium salt.

4. The process of claim 1, wherein the solvent system is a mixture of solvents comprising at least one ionic liquid and at least one nonionic solvent.

5. The process of claim 1, wherein the aminating agent is selected from ammonia, ammonia-releasing compounds, primary amines, secondary amines, and tertiary amines.

6. The process of claim 1, wherein the aminating agent is selected from n-butylamine, trimethylamine, ethanolamine, sodium azide, and mixtures thereof.

7. The process of claim 1, wherein the chlorinated polysaccharide or oligosaccharide has a degree of subsitution DS of 0.5 to 3 and a degree of polymerization DP of 10 to 100.

8. A-The process of claim 1, wherein step c) is carried out in liquid phase.
